(19) United States
(12) Patent Application Publication
(10) Pub. No.: US 2006/0125398 A1
(43) Pub. Date: Jun. 15, 2006

(54) Plasma display panel

(75) Inventor: Sung Yong Ahn, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/284,003

(22) Filed: Nov. 22, 2005

(30) Foreign Application Priority Data
Nov. 23, 2004 (KR) 2004-96625
Dec. 1, 2004 (KR) 2004-100050
Dec. 1, 2004 (KR) 2004-103862

(51) Int. Cl. H01J 17/49

(52) U.S. Cl. 313/583; 313/584

(57) ABSTRACT

A plasma display panel includes an upper plate and a lower plate with a low dielectric constant. By adjusting factors such as the widths of an electrode and a barrier rib within an optimum range, panel capacitance can be reduced and the efficiency of a sustain discharge or an address discharge can be improved.

### BACKGROUND OF THE INVENTION

1. Field of the Invention

The present invention relates to a plasma display panel (PDP) and, more particularly, to a PDP capable of reducing capacitance of a panel.

2. Description of the Related Art

A PDP is an apparatus in which discharge cells are formed between a rear substrate with barrier ribs formed thereon and a front substrate facing the rear substrate, and when an inert gas inside each discharge cell is discharged by a high frequency voltage, vacuum ultraviolet rays are generated to illuminate phosphor to thereby allow displaying of images.

FIG. 1 is a perspective view showing the structure of a general PDP, and FIG. 2 is a sectional view showing a discharge cell of the general PDP.

First, discharge cells are formed by a plurality of barrier ribs 24 separating a discharge space on a rear substrate 18 facing a front substrate 10.

An address electrode X is formed on the rear substrate 18, and a scan electrode Y and a sustain electrode Z are formed as a pair on the front substrate 10. The address electrode X crosses the other electrodes Y and Z, and in this respect, the rear substrate 18 in FIG. 2 is shown as having been rotated by 90° for the sake of explanation.

A dielectric layer 22 for accumulating wall charges is formed on the rear substrate 18 with the address electrode X formed thereon.

The barrier ribs 24 are formed on the dielectric layer 22 to define a discharge space therebetween and prevent a leakage of ultraviolet rays and visible light generated by a discharge to an adjacent discharge cell. Phosphor 26 is coated on the surface of the dielectric layer 22 and on the surface of the barrier ribs 24.

Because an inert gas is injected into the discharge space, the phosphor 26 is excited by the ultraviolet rays generated during a gas discharge to generate one of red, green and blue visible light.

The scan electrode Y and the sustain electrode Z formed on the front substrate 10 include transparent electrodes 12Y and 12Z and bus electrodes 13Y and 13Z, respectively, and cross the address electrode 12X. A dielectric layer 14 and a protective film 16 are formed to cover the scan electrode Y and the sustain electrode Z.

The discharge cell with such a structure is selected by a facing discharge formed between the address electrode X and the scan electrode Y, and the discharge is sustained by a surface discharge between the scan electrode Y and the sustain electrode Z, to thus emit visible light.

The scan electrode Y and the sustain electrode Z include the transparent electrodes 12Y and 12Z and the bus electrodes 13Y and 13Z having the smaller width than the transparent electrodes 12Y and 12Z and formed on one portion of the transparent electrodes 12Y and 12Z, respectively.

FIG. 3 shows a frame of the general PDP.

With reference to FIG. 3, in the plasma display panel, in order to represent gray levels of an image, one frame is divided into several sub-fields (SF1 to SF8) each having a different number of times of illumination and driven according to time division. Each sub-field (SF1˜SF8) includes a reset period for initializing wall charges within the discharge cell, an address period for selecting a scan line and then selecting a discharge cell from the selected scan line, and a sustain period (S) for implementing a gray level according to the number of times that a sustain discharge occurs.

Gray levels implemented in the sub-fields including the reset period, the address period and the sustain period are accumulated during one frame, and in case where an image is represented with 256 gray levels, as shown in FIG. 3, a frame period (16.67 ms) corresponding to 1/60 seconds is divided into eight sub-fields (SF1 to SF8) and each sub-field represents 2ⁿ (n=0, 1, 2, 3, 4, 5, 6, 7) gray levels.

Having characteristics of storing energy according to electric field and inducing a current by voltage variation, the discharge cells of the PDP for displaying images can be equivalent to a capacitor, and capacitance of the panel affects reactive power and the discharge efficiency.

In detail, as for the relationship between the capacitance of the panel and the reactive power and the discharge efficiency, under the condition that a load is high like a full white pattern during the sustain period, discharge power is greater than reactive power, whereas under the practical condition that a load is about 20% or smaller like a general TV broadcast program or a movie, the reactive power is greater than the discharge power. In such a practical condition, more sustain pulses in the full white condition are applied to emphasize luminance than under the practical condition, so in order to enhance the discharge efficiency with the same power consumption, reactive power according to switching must be reduced during the sustain period.

In addition, when a specific input pattern that ON/OFF is repeated in up/down/left/right directions is inputted, the reactive power is increased during the address period, causing problems of an increase in power consumption, waveform distortion, an erroneous discharge, and IC heating.

Especially, in case of a panel of a HD class or higher employing single scanning, the address period is lengthened double compared with a case where dual scanning is employed and the number of times of switching of the address voltage is also increased double, further increasing reactive power consumption during the address period.

In an effort to reduce such reactive power, in the related art, a discharge gas such as high Xe is used to improve the discharge efficiency. In this case, however, if the discharge gas is contained by 10% or more, a sustain voltage or the address voltage are inevitably increased together to rather increase reactive power, failing to improve the discharge efficiency under the practical conditions.

Therefore, designing for reducing capacitance Cyz of an upper plate, capacitance Cxx of a lower plate and upper/lower plate panel capacitance Cxy is necessary to reduce the reactive power during the sustain period and the address period and enhance the discharge efficiency.

### SUMMARY OF THE INVENTION

The present invention is designed to solve such a problem of the related art, and therefore, an object of the present invention is to provide a plasma display apparatus capable of reducing panel capacitance.

To achieve the above object, there is provided a plasma display panel (PDP) including an upper plate and a lower plate. The upper plate includes a scan electrode and a sustain electrode, and the lower plate includes an address electrode. The upper plate or the lower plate is formed to have a dielectric constant of 10 or lower.

The scan electrode and the sustain electrode are arranged to be symmetrical with a scan electrode and a sustain electrode of an adjacent discharge cell.

The upper plate additionally includes an upper dielectric layer stacked on the scan electrode and the sustain electrode, and the upper dielectric layer has a dielectric constant of 10 or lower and the thickness of 35 μm or smaller.

The scan electrode and the sustain electrode are formed of a transparent electrode and a metal bus electrode, respectively, and the transparent electrodes are formed to be separated by a distance of 90 μm therebetween and have the width of 200 μm or smaller.

To achieve the above object, there is also provided a plasma display panel (PDP) including an upper plate and a lower plate as coupled. At least one or more electrodes are formed on the upper and lower plates. An upper dielectric layer stacked on the electrode of the upper plate is formed such that a portion thereof overlapping with the electrode is thicker than a portion that does not overlap with the electrode.

The upper dielectric layer having the portions each with a different thickness has a dielectric constant of 10 or lower, and the thickness of the portion overlapping with the electrode is 35 μm or smaller and the thickness of the portion which does not overlap with the electrode is 10 μm or smaller.

To achieve the above object, there is also provided a plasma display panel (PDP) including: an upper plate and a lower plate. The upper plate includes a scan electrode and a sustain electrode formed in a first direction. The lower plate includes an address electrode formed in a second direction that crosses the first direction, and vertical barrier ribs formed in the second direction to separate R, G and B pixel discharge cells and horizontal barrier ribs separating a panel line in the first direction. The horizontal and vertical barrier ribs are formed such that their lower width is larger than their upper width.

The lower width of the horizontal barrier rib is larger by 1.6 times to 2 times than the upper width thereof, while the lower width of the vertical barrier rib is larger by 1.4 times to 1.9 times than the upper width.

The horizontal and vertical barrier ribs have the height of 120 μm or larger, and have a dielectric constant of 10 or lower or are formed as a Pb-free barrier ribs having a low dielectric constant.

A phosphor layer is formed with a thickness of 10 μm or smaller on a lower dielectric layer stacked on the address electrode and on the barrier rib.

The scan electrode and the sustain electrode may be formed on the upper plate such that an area thereof overlapping with the address electrode formed on the lower plate is 14,000 μm² or smaller, and a portion where the upper and lower plates electrodes overlap does not overlap with the barrier rib. The scan electrode and the sustain electrode have a width of 200 μm or smaller, and the address electrode of the lower plate has a width of 80 μm or smaller.

To achieve the above object, there is also provided a plasma display panel (PDP) including an upper plate and a lower plate as coupled. The upper plate includes a scan electrode and a sustain electrode and the lower plate includes an address electrode. The address electrode has a protruding portion with a first width overlapping with the scan electrode, and other portion, than the protruding portion, of the address electrode has a second width smaller than the first width.

The area of the address electrode overlapping with the scan electrode by the protruding portion is 14,000 μ² or smaller and does not overlap with barrier ribs formed on the lower plate.

The first width of the address electrode is 100 μm to 120 μm, and the second width thereof is 20 μm to 80 μm.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing a discharge cell of a general plasma display panel (PDP).

FIG. 2 is a sectional view showing the discharge cell of the general PDP.

FIG. 3 shows the construction of a frame for implementing 256 gray levels.

FIG. 4 is a view equivalently showing capacitance of upper and lower plates of the general PDP.

FIG. 5 is a perspective view of a PDP in accordance with a first embodiment of the present invention.

FIGS. 6 and 7 are sectional views showing a PDP in accordance with a second embodiment of the present invention.

FIG. 8 is a sectional view of vertical barrier ribs of the PDP in accordance with a third embodiment of the present invention.

FIG. 9 is a sectional view of horizontal barrier ribs of the PDP in accordance with a third embodiment of the present invention.

FIG. 10 is a sectional view of a discharge cell of the PDP in accordance with the third embodiment of the present invention.

FIG. 11 shows the structure of an electrode of the PDP in accordance with the third embodiment of the present invention.

FIG. 12 shows the structure of an electrode of the PDP in accordance with a fourth embodiment of the present invention.

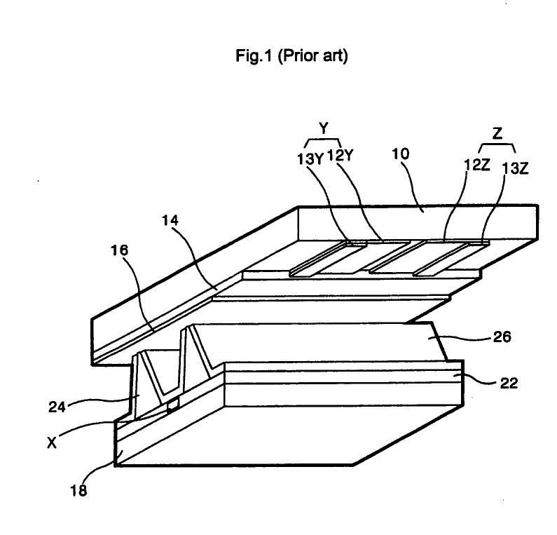

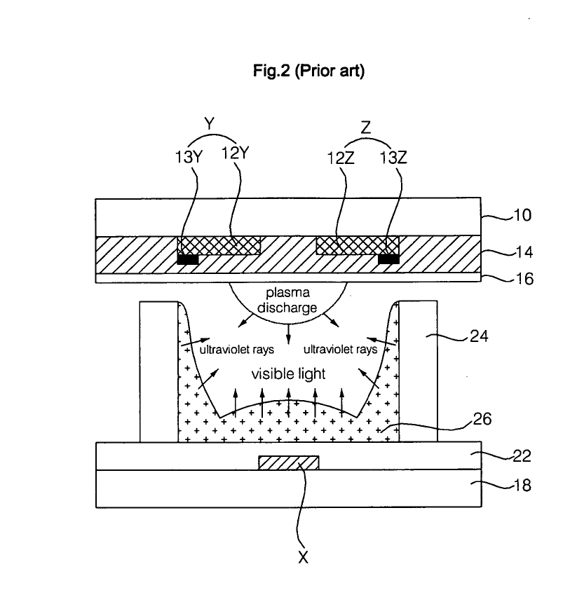

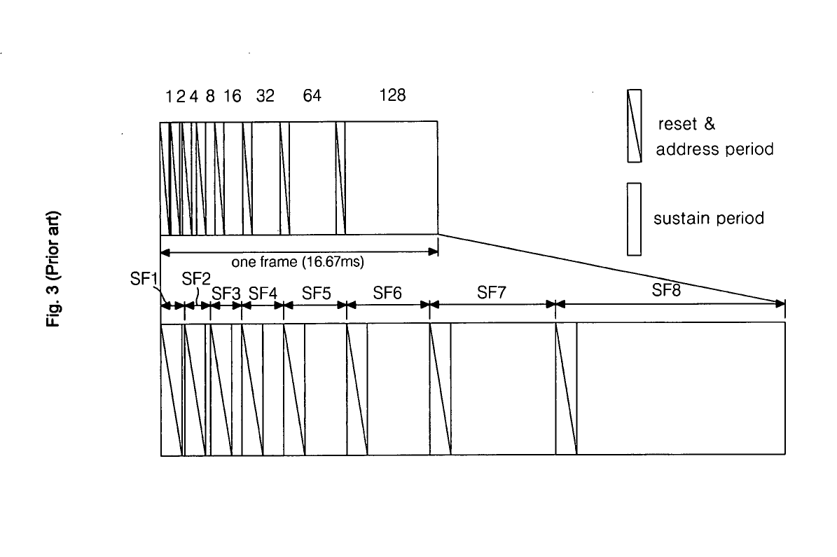

### DETAILED DESCRIPTION OF THE INVENTION

The plasma display apparatus and the structure of its discharge cell in accordance with the embodiments of the present invention will now be described with reference to the accompanying drawings.

There can be a plurality of embodiments of the PDP in accordance with the present invention without being limited to those described in the present invention.

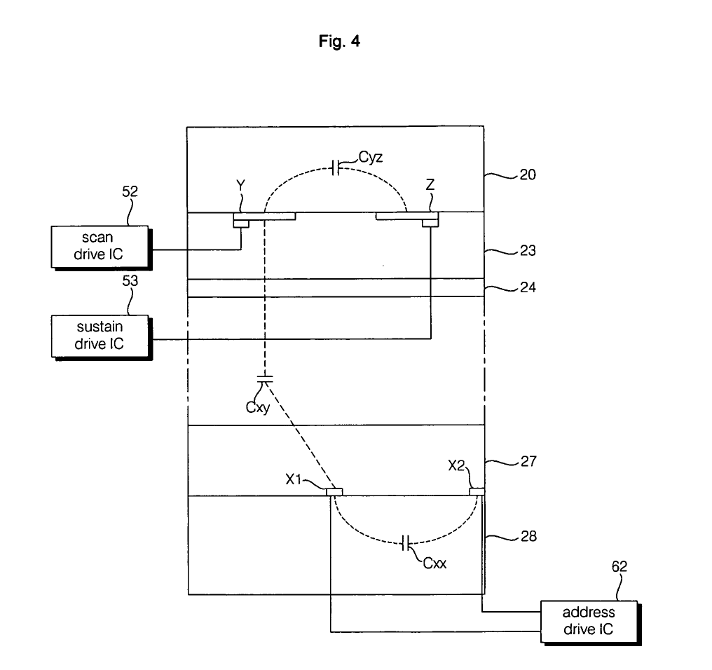

The first to fourth embodiments of the present invention will be described with reference to FIGS. 4 to 12.

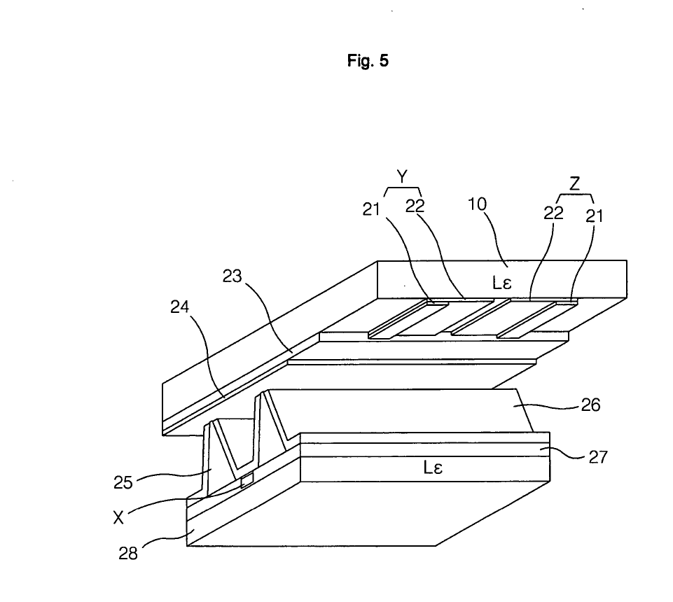

FIG. 4 is a view equivalently showing capacitance of upper and lower plates of the general PDP, and FIG. 5 is a perspective view of a PDP in accordance with a first embodiment of the present invention.

With reference to FIG. 4, a first capacitance Cyz is formed between a scan electrode (Y) and a sustain electrode (Z) on an upper plate 20 of the PDP in accordance with the present invention. A scan drive IC 52 and a sustain drive IC 53 for supplying a drive signal are connected with the scan electrode (Y) and the sustain electrode (Z), respectively.

A second capacitance Cxx is formed between address electrodes X1 and X2 at a lower plate 28 of the panel, and an address drive IC 62 supplies a drive signal required for the address electrodes X1 and X2.

A third capacitance Cxy is formed between the scan electrode Y of the upper plate 20 and the address electrode X1 of the lower plate 28.

With reference to FIG. 5, the PDP in accordance with the first embodiment of the present invention is characterized in that the upper plate 20 and the lower plate 28 have a low dielectric constant (Lε) of 10 or lower in order to reduce the first to third capacitances Cyz, Cxx and Cxy.

The scan electrode (Y) and the sustain electrode (Z) are formed on the upper plate 20, and the address electrode (X) is formed on the lower plate 28. A discharge space is formed at a crossing of the scan electrode (Y), the sustain electrode (Z) and the address electrode (X).

Preferably, the scan electrode (Y) and the sustain electrode (Z) of a discharge cell are arranged to be symmetrical with the scan electrode (Y) and the sustain electrode (Z) of an adjacent discharge cell.

In such a (YZ|ZY) electrode disposition structure, since the same electrodes (Z|Z) are disposed between adjacent discharge cells, an additional electric field is not formed and thus the first capacitance Cyz can be reduced compared with a (YZ|YZ) electrode disposition structure.

In order to reduce capacitance of the panel, the upper and lower plates 20 and 28 have the dielectric constant (Lε) of 10 or lower, and preferably, 1 to 6, respectively. The upper and lower plates 20 and 28 can be fabricated with any of known low dielectric constant glass compositions.

The scan electrode (Y) and the sustain electrode (Z) include a transparent electrode 22 and a metal bus electrode 21, respectively, and a dielectric layer 23 covering the electrodes and a protective film 24 are stacked thereon.

Preferably, the width of the transparent electrode is 200 μm or smaller and the transparent electrodes are separated with a long gap of 90 μm or larger therebetween. The longer the gap between the electrodes Y and Z of the upper plate 20 is, the more the first capacitance Cyz is reduced.

A lower dielectric layer 27 is stacked on the lower plate 28, and barrier ribs 25 for separating the discharge cell are formed thereon. Phosphor 26 is coated on a surface of the lower dielectric layer 27 and the barrier ribs 25.

The upper dielectric layer 23 of the upper plate 20 and the lower dielectric layer 27 of the lower plate 28 also have a dielectric constant of 10 or lower, and since the first to third capacitances Cyz, Cxx and Cxy are reduced as the thickness of the upper and lower dielectric layers 23 and 27 becomes small, preferably, the upper and lower dielectric layers are formed to have the thickness of 35 μm or smaller.

In the first embodiment of the present invention, by lowering the dielectric constant of the upper and lower plates 20 and 28 to the dielectric constant (Lε) of 1˜6 in consideration of a stable physical property of the glass composition and capacitance, the overall capacitance (C) of the upper and lower plates can be reduced as noted by equation (1) shown below:

$$C = ɛ \frac{/ S}{d} \qquad ( 1 )$$

wherein ‘S’ is an area of electrodes forming capacitance, ‘d’ is a distance between the electrodes, and ‘ε’ is the dielectric constant between the electrodes.

$$i = C \frac{ⅆ}{ⅆ t} v \qquad ( 2 )$$

With reference to FIG. 4, when the dielectric constant of the upper plate 20 is lowered, capacitance of the upper plate is reduced according to equation (1) and a current passing through the scan drive IC 52 and the sustain drive IC 53 is also reduced according to equation (2). In addition, as the drive current is reduced, power consumption at each of the drive ICs 52 and 53 is also reduced.

Likewise, when the dielectric constant of the lower plate 28 is lowered, capacitance of the lower plate is reduced according to equation (1) and a current passing through the address drive IC 62 and power consumption are reduced according to equation (2).

The dielectric constant of the upper plate 20 or the lower plate 28 can be also lowered in a different method. That is, the content of alkali metal having conductivity contained in the upper plate or the lower plate can be reduced to lower the dielectric constant.

In addition, because dielectric constant is increased as dielectric strength or a working voltage of glass is increased, it is preferred that the upper plate 20 or the lower plate 28 is fabricated to have small dielectric strength and a small working voltage.

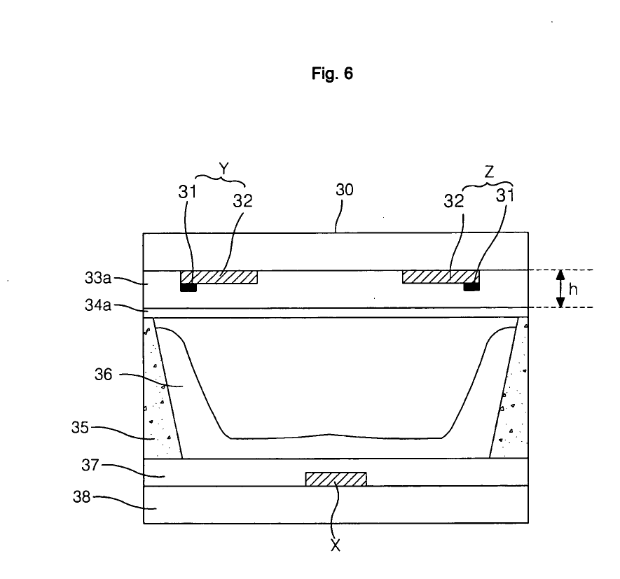

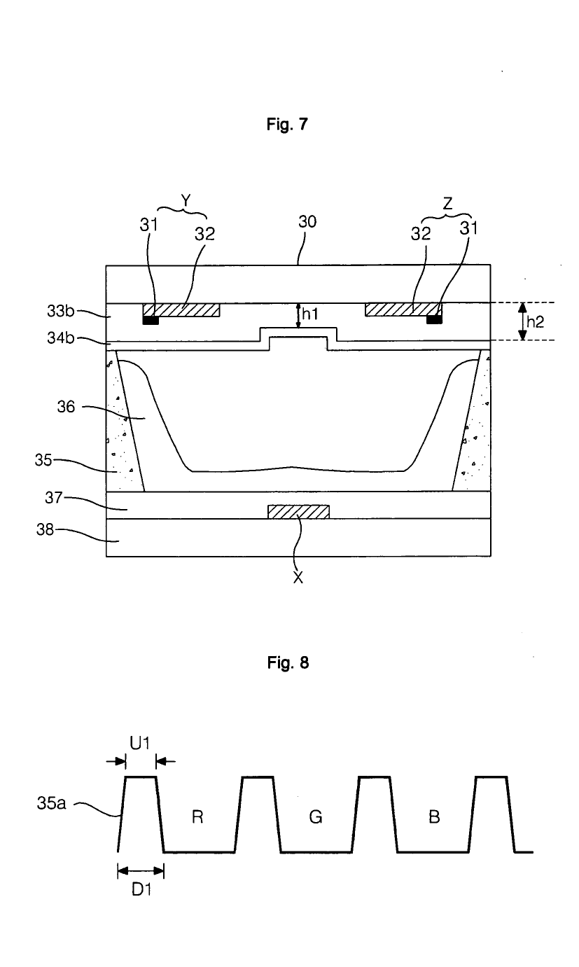

FIGS. 6 and 7 are sectional views showing a PDP in accordance with a second embodiment of the present invention, in which the upper plate is shown as having been rotated by 90°.

The PDP in accordance with the second embodiment of the present invention is characterized in that, in order to reduce the first capacitance Cyz, an upper dielectric layer 33a has a thickness (h) of 10 μm or smaller, or a thickness (h2) of portions of an upper dielectric layer 33b overlapping with the scan electrode (Y) and the sustain electrode (Z) and a thickness (h1) of other portion of the upper dielectric layer 33b are different.

The structure of the discharge cell will now be described with reference to FIGS. 6 and 7. As shown, the scan electrode (Y) and the sustain electrode (Z) are formed on an upper plate 30, and the address electrode (X) is formed on a lower plate 38. The scan electrode (Y) and the sustain electrode (Z) include a transparent electrode 31 and a metal bus electrode 32 having a smaller line width than the transparent electrode 31 and formed on one portion of the transparent electrode 31, respectively.

Upper dielectric layers 33a and 33b for accumulating wall charges generated during a plasma discharge and protective films 34a and 34b for protecting the upper dielectric layers 33a and 33b are sequentially stacked on the upper plate 30.

On the lower plate 38, there are sequentially formed a lower dielectric layer 37 and a barrier rib 35, and a phosphor layer 36 is coated on a surface of the lower dielectric layer 37 and the barrier rib 35.

As shown in FIG. 6, the thickness (h) of the upper dielectric layer 33a is 10μ or smaller, and the smaller the thickness of the upper dielectric layer, the more capacitance of the panel is reduced.

In this respect, however, if the thickness (h) of the upper dielectric layer 33a is too small, the panel capacitance could be reduced, but wall charges generated according to the plasma discharge are not sufficiently formed. Thus, in order to solve such a problem, the PDP adopting a differential dielectric layer as shown in FIG. 7 is proposed.

With reference to FIG. 7, the same reference numerals as those in the above-described embodiment are given to the substantially same elements in this embodiment, and repetitive descriptions will be omitted.

In this embodiment, the upper dielectric layer 33b is formed to have a different thickness according to portions. Namely, the thickness (h2) of the portions of the upper dielectric layer 33b which overlap with the scan electrode (Y) and the sustain electrode (Z) is larger than the thickness (h1) of the other portion of the upper dielectric layer 33b.

The dielectric constant of the upper dielectric layer 33b according to each thickness will be described with reference to [Table 1] shown below.

TABLE 1

| First capacitance | Thickness of | Thickness of | | |
|---|---|---|---|---|
| (Cyz) | dielectric (h2) | Dielectric (h1) | | Dielectric constant |
| A | 40 μm | 0 | μm | 11 |
| B | 35 μm | 5 | μm | 10 |
| C | 30 μm | 10 | μm | 9 |

As shown in [Table 1], in order to have the dielectric constant of 10 or lower, the upper dielectric layer 33b is formed such that the portion thereof overlapping with the upper electrodes Y and Z has the thickness (h2) of 35 μm or smaller and the other portion of the upper dielectric layer 33b is set to have the thickness (h1) of about 10 μm or smaller.

Accordingly, sufficient wall charges can be formed at the portion of the upper dielectric layer 33b with the larger thickness (h2) according to the plasma discharge, and the first capacitance Cyz at the portion of the upper dielectric layer 33b with the smaller thickness (h1) can be reduced.

FIGS. 8 to 11 are sectional views of barrier ribs of the PDP in accordance with a third embodiment of the present invention. The PDP in accordance with the third embodiment of the present invention is characterized in that upper and lower widths of the barrier ribs are different in order to reduce the second and third capacitances Cxy and Cxx.

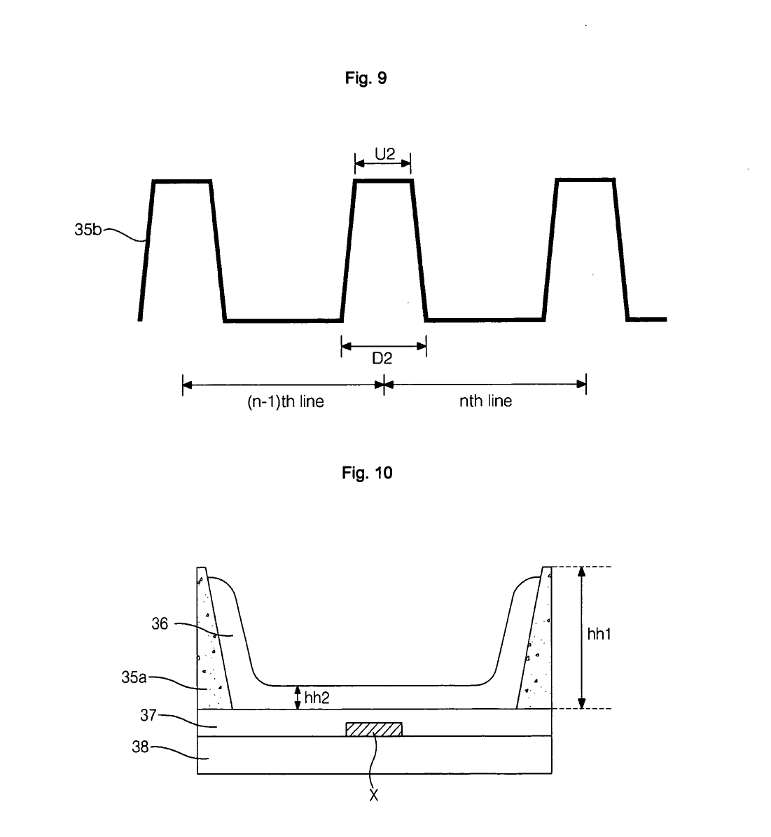

FIG. 8 is a sectional view of a vertical barrier rib 35a of the discharge cell and FIG. 9 is a sectional view of a horizontal barrier rib 35b of the discharge cell.

The vertical barrier rib 35a is formed in the same direction as the address electrode (X), while the horizontal barrier rib 35b is formed in the same direction as the scan electrode (Y) and the sustain electrode (Z). The same reference numerals as those in the above-described embodiment are given to the substantially same elements in this embodiment, and repetitive descriptions will be omitted.

With reference to FIG. 8, vertical barrier ribs 35a separate each of R, G and B discharge cells, prevent a leakage of a discharge gas between discharge cells, and prevent influence of ultraviolet rays and visible light emitted from each discharge space on an adjacent cell.

Generally, the process is easy with a wide vertical barrier rib 35a, but if the barrier rib is too wide, capacitance would be increased. Thus, in this embodiment of the present invention, the vertical barrier rib 35a has the upper width U1 of 40 μm˜55 μm and the lower width D1 of 60 μm˜90 μm to facilitate the barrier rib formation process as well as reduce panel capacitance.

That is, preferably, the lower width D1 of the vertical barrier rib 35a is larger by 1.4 times to 1.9 times than the upper width U1.

With reference to FIG. 9, the horizontal barrier ribs 35b separate discharge cells corresponding to upper and lower lines formed in a horizontal direction of the panel.

Unlike the vertical barrier ribs 35a separating the R, G and B sub-discharge cells, the horizontal barrier ribs 35b separate the discharge cells corresponding to the horizontal line, so they have a larger width. Namely, the lower width D2 of the horizontal barrier rib is 160 μm˜200 μm while the upper width U2 of the horizontal barrier rib is 100 μm˜140 μm.

In this manner, preferably, the horizontal barrier rib 35b is formed such that its lower width D2 is larger by 1.6 times to 2 times than the upper width U2 thereof.

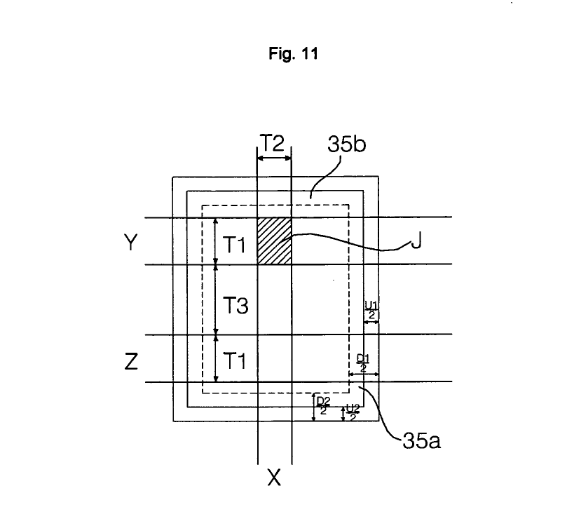

FIG. 10 is a sectional view of the discharge cell in accordance with the third embodiment of the present invention. In this embodiment of the present invention, a height (hh1) of the vertical barrier rib 35a is 130 μm or greater, and the horizontal barrier rib 35b also have the same height (hh1). As the vertical barrier rib 35a and the horizontal barrier rib 35b, a Pb-free barrier rib with the dielectric constant of 10 or lower can be used.

The phosphor layer 36 with the thickness (hh2) of 10 μm or smaller is formed on the lower dielectric layer 37 stacked on the address electrode (X) and on the barrier ribs 35a and 35b.

Capacitance according to the upper and lower widths of the barrier rib, the height of the barrier rib and the thickness of the phosphor layer will be described with reference to [Table 2] and [Table 3] shown below.

TABLE 2

| Second | Upper/lower | Upper/lower | | |
|---|---|---|---|---|
| capaci- | width of | width of | | Dielectric |
| tance | vertical barrier | horizontal | Thickness of | constant of |
| (Cxx) | rib | barrier rib | phosphor layer | barrier rib |
| A | 60/110 | 180/300 | 14 | 12 |
| B | 55/90 | 120/200 | 10 | 10 |
| C | 50/70 | 60/120 | 6 | 8 |

TABLE 3

| Third | Upper/lower | Upper/lower | Thickness | Height | |
|---|---|---|---|---|---|
| capaci- | width of | width of | of | of | Dielectric |
| tance | vertical | horizontal | phosphor | barrier | constant of |
| (Cxy) | barrier rib | barrier rib | layer | rib | barrier rib |
| A | 60/110 | 180/300 | 14 | 120 | 12 |
| B | 55/90 | 120/200 | 10 | 130 | 10 |
| C | 50/70 | 60/120 | 6 | 140 | 8 |

As noted in [Table 2], as the width of the barrier rib becomes small or the thickness of the phosphor layer becomes small, or as the dielectric constant of the barrier rib is reduced, the second capacitance Cxx is reduced.

As noted in [Table 3], as the width of the barrier rib becomes small and the height of the barrier rib is increased, the distance between the electrodes of the upper and lower plates becomes longer and thus the third capacitance Cxy is reduced. Also, as the thickness of the phosphor layer becomes small and the dielectric constant of the barrier rib is reduced, the third capacitance Cxy is reduced.

In particular, in order to reduce the third capacitance Cxy formed between the upper and lower plates, as shown in FIG. 11, a region where the scan electrode (Y) formed at the upper plate and the address electrode (X) formed at the lower plate overlap must be small. When the region where the electrodes overlap is an upper/lower plate electrode overlap portion (J), the area of the overlap portion (J) is preferably 14,000 μm² or smaller.

The upper/lower plate electrode overlap portion (J) is formed not to overlap with the barrier ribs 35a and 35B whose upper and lower widths are different.

The scan electrode (Y) and the sustain electrode (Z) of the upper plate are separated with a distance of 90 μm or longer therebetween, forming a long gap (T3) therebetween, and the width (T1) of each electrode is 200 μm or smaller. At this time, the address electrode (X) of the lower plate has the width (T2) of 80 μm or smaller.

In this manner, in the third embodiment of the present invention, by forming the vertical barrier rib 35a and the horizontal barrier rib 35b such that they have the different upper and lower widths, the second and third capacitances Cxx and Cxy can be reduced. As for formation of the barrier ribs, the barrier ribs can be formed according to any known techniques such as a screen printing method, an addition method, a photosensitive pasting method, an LTCCM (Low Temperature Cofired Ceramic on Metal) method, a sand blasting method, and the like.

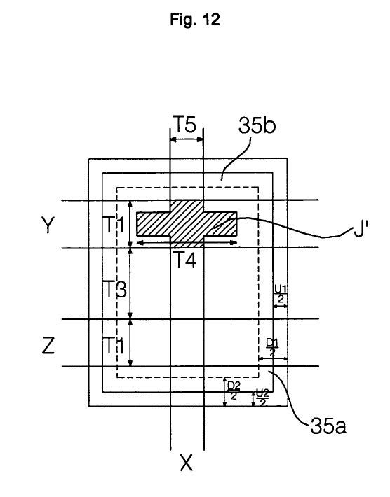

FIG. 12 is a plan view of a PDP in accordance with a fourth embodiment of the present invention. The PDP in accordance with the fourth embodiment of the present invention is characterized in that the width of the address electrode (X) crossing the scan electrode (Y) is larger than other portion thereof to reduce the second and third capacitances Cxx and Cxy.

The same reference numerals as those in the above-described embodiment are given to the substantially same elements in this embodiment, and repetitive descriptions will be omitted.

In the fourth embodiment of the present invention, the address electrode (X) includes a protruding portion with a first width (T4) at a portion (J′) thereof overlapping with the scan electrode (Y), while the other portion thereof has a second width (T5) smaller than the first width (T4).

In this case, since the area overlapping with the scan electrode (Y) extends by the protruding portion of the address electrode (X), an address discharge can occur stably, and since the second width (T5) of the address electrode is narrow to make the area of the overlap portion (J′) 14,000 μm² or smaller, the second and third capacitances Cxx and Cxy can be reduced.

At this time, the first width (T4) of the address electrode (X) is 100 μm˜120 μm, while the second width (T5) thereof is 20 μm˜80 μm.

In addition, in the fourth embodiment of the present invention, the scan electrode (Y) and the sustain electrode (Z) are separated with a distance of 90 μm or longer therebetween, forming a long gap therebetween, and the width (T1) of each electrode is 200 μm or smaller.

Accordingly, the long gap between the scan electrode (Y) and the sustain electrode (Z) improves the sustain discharge efficiency, and the increased width of the portion of the address electrode (X) overlapping with the scan electrode (Y) improves the address discharge efficiency, and the narrow width of the other portion of the address electrode not overlapping with the scan electrode (Y) reduces the second and third capacitances Cxx and Cxy.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A plasma display panel comprising:
an upper plate comprised of a scan electrode and a sustain electrode;
a lower plate comprised of an address electrode,
wherein the upper or lower plate has a dielectric constant of 10 or lower.

2. The panel of claim 1, wherein scan and sustain electrodes of one discharge cell are arranged to be symmetrical with scan and sustain electrodes of an adjacent discharge cell.

3. The panel of claim 1, wherein the upper plate comprises an upper dielectric layer stacked on the scan electrode and the sustain electrode, and the upper dielectric layer has a dielectric constant of 10 or lower.

4. The panel of claim 3, wherein the upper dielectric layer has a thickness of 35 μm or smaller.

5. The panel of claim 1, wherein the scan electrode and the sustain electrode are formed of a transparent electrode and a metal bus electrode, respectively, and the transparent electrodes are separated with a distance of 90 μm therebetween.

6. The panel of claim 5, wherein the width of the transparent electrodes is 200 μm or smaller.

7. A plasma display panel comprising:
an upper plate; and
a lower plate facing the upper plate,
the upper plate and the lower plate being coupled,
wherein at least one or more electrodes are formed on the upper and lower plates, and an upper dielectric layer is stacked on the electrode of the upper plate such that a thickness of a portion of the upper dielectric layer overlapping with the electrode is larger than that of a portion thereof which does not overlap with the electrode.

8. The panel of claim 7, wherein the upper dielectric layer has a dielectric constant of 10 or lower.

9. The panel of claim 7, wherein the thickness of the upper dielectric layer is 35 μm or smaller.

10. The panel of claim 7, wherein the portion of the upper dielectric layer overlapping with the electrode has the thickness of 35 μm or smaller, and the portion thereof which does not overlap with the electrode has the thickness of 10 μm or smaller.

11. A plasma display panel comprising:
an upper plate comprised of a scan electrode and a sustain electrode formed in a first direction; and
a lower plate comprised of an address electrode formed in a second direction crossing the first direction, and a vertical barrier rib formed in the second direction to separate R, G and B pixel discharge cells and a horizontal barrier rib separating a panel line in the first direction,
wherein the horizontal and vertical barrier ribs have a lower width larger than the upper width thereof.

12. The panel of claim 11, wherein the lower width of the horizontal barrier rib is larger by 1.6 times to 2 times than the upper width thereof.

13. The panel of claim 11, wherein the lower width of the vertical barrier rib is larger by 1.4 times to 1.9 times than the upper width thereof.

14. The panel of claim 11, wherein the horizontal or vertical barrier rib has a height of 120 μm or larger.

15. The panel of claim 11, wherein the horizontal or vertical barrier rib has a dielectric constant of 10 or lower.

16. The panel of claim 11, wherein the horizontal or vertical barrier rib is a Pb-free barrier rib.

17. The panel of claim 11, wherein a phosphor layer with a thickness of 10 μm or smaller is formed on the lower dielectric layer stacked on the address electrode and on the barrier rib formed at the lower plate.

18. The panel of claim 11, wherein an upper and lower plate electrode overlap portion where the scan electrode and the sustain electrode of the upper plate and the address electrode of the lower plate overlap has an area of 14,000 μm².

19. The panel of claim 18, wherein the upper and lower plate electrode overlap portion does not overlap with a portion of the barrier rib.

20. The panel of claim 18, wherein when the scan electrode and the sustain electrode of the upper plate are formed with a width of 200 μm or smaller, the address electrode of the lower plate is formed with a width of 80 μm or smaller.

21. A plasma display panel comprising:
an upper plate comprised of a scan electrode and a sustain electrode; and
a lower plate comprised of an address electrode,
wherein the address electrode comprises a protruding portion with a first width overlapping with the scan electrode, other portion, than the protruding portion, of the address electrode having a second width smaller than the first width.

22. The panel of claim 21, wherein the protruding portion of the address electrode has the area of 14,000 μm² or smaller.

23. The panel of claim 21, wherein the protruding portion of the address electrode does not overlap with a barrier rib formed at the lower plate.

24. The panel of claim 21, wherein the first width of the address electrode is 100 μm˜120 μm and the second width thereof is 20 μm˜80 μm.

25. The panel of claim 21, wherein a phosphor layer with the thickness of 10 μm or smaller is formed on the lower dielectric layer stacked on the address electrode and on the barrier rib of the lower plate.
